(19) United States
(12) Patent Application Publication
(10) Pub. No.: US 2009/0123620 A1
(43) Pub. Date: May 14, 2009

(54) Automated Application of an Antimycotic Composition to Sliced Foodstuffs and an Antimycotic Application Apparatus

(76) Inventors: Thomas R. Hiti, Plymouth, WI (US); Gerald Kraus, Plymouth, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/939,669

(22) Filed: Nov. 14, 2007

(51) Int. Cl. A23C 3/08; A23L 3/3499

(52) U.S. Cl. 426/334; 426/335

(57) ABSTRACT

A method for applying a powdered antimycotic composition to a foodstuff, the method including mixing a powdered antimycotic composition in an air stream, applying a uniform coating of antimycotic composition to each surface of a bulk foodstuff and slicing the foodstuff into a plurality of slices having the desired antimycotic surface concentration on each surface thereof.

### BACKGROUND OF THE INVENTION

### Field of the Invention

The present invention relates generally to the application of an antimycotic composition to the surface of a sliced food product, and more particularly to a method of applying a powdered antimycotic and/or antimicrobial agent, such as natamycin, to a foodstuff during the slicing process and a system for the application thereof.

Natamycin (pimaricin) is a naturally occurring antimycotic agent produced by the bacterium Streptomyces natalensis. Natamycin inhibits the growth of molds and yeasts by binding to and destroying the fungal cell membrane.

Natamycin is classified as a GRAS (Generally Recognized as Safe) substance by the U.S. Food and Drug Administration, and is also widely used as a natural food preservative in over forty countries, including the European Union and Japan. Natamycin has been widely used as a natural food additive in foods such as salad dressings, sauces and marinades.

In these types of products, natamycin is homogeneously incorporated directly into the foodstuff during the production process. It can be added in dry form to liquids, slurries, pastes and semisolids when adequate mixing can be accomplished, or pure natamycin can be mixed with one or more of the dry ingredients and then added to a given food product.

Natamycin has also been of interest in the surface treatment of dairy food products because it is highly active against yeast and molds, as opposed to bacteria In particular, because cheese is ripened in high humidity, open air environments, it is an ideal “food” for the growth of molds and fungi.

The use of natamycin on the surface cheese, allows manufacturers to produce cheese that is acceptable to the aesthetic demands of consumers (no discoloration or off flavors) by eliminating the growth of mold and yeast that occurs during the ripening process and storage. Natamycin coated cheese has a lower risk of mycotoxin growth compared to untreated cheese products, resulting in a longer shelf life.

Automated natamycin application typically occurs within a high speed production process, after cutting the cheese into its desired consumer-packaged form. The presliced, precubed and/or pregrated cheese is then surface-treated by dipping, tumbling or spraying the cheese pieces with a solution or liquid suspension of natamycin. However, the use of liquid natamycin in high-speed process line can cause upstream and downstream manufacturing difficulties, such as corrosion of equipment and/or cross-contamination. In addition, natamycin has very low water solubility and extremely high photosensitivity, further complicating the application process and rendering it difficult control the surface concentration and consistency of the natamycin coating.

It is accordingly the primary objective of the present invention to provide, at least in part, a method of automating the application of a dry, powdered antimycotic composition, including, in particular, natamycin, to the surface of a larger foodstuff before cutting or slicing the foodstuff for consumer packaging. It will be seen that the present methods include the automatic coating of both surfaces the foodstuff with a dry and/or particulated natamycin composition, eliminating the possibility of liquid corrosion of processing equipment and liquid cross-contamination of the foodstuff.

It is a further object of the present invention to provide a system for the automatic application of a dry natamycin composition, such system being easily integrated into an existing cheese slicing and/or cutting line. The present invention further provides dry coated sliced cheese or food product, including a sufficient amount of dry natamycin coating to prevent the growth of molds and/or fungi, while not exceeding the applicable governmental concentration limitations for surface coated foodstuffs. The present methods and system provides a sliced, dry-coated foodstuff including a substantially uniform layer or layers of natamycin coating.

The methods of the prevent invention and the systems incorporated herein must be easily incorporated into an existing application process, or easily installed into a new construction. The system is both durable and long lasting, and it should also require little or no maintenance to be provided by the user throughout its operating lifetime. In order to enhance the market appeal of the apparatus of the present invention, it should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. With this invention, a method for the automatic application of a substantially dry and/or powdered antimycotic composition, such as natamycin, to a foodstuff and a system for application of a substantially dry, powdered natamycin is provided.

The methods of the present invention include, in part, applying a powder containing an antimycotic composition to the surface of cheese logs prior to being fed into a cheese slicer. The method comprises providing a bulk foodstuff precut into a size capable of being processed within a conventional slicer or cubing device; providing an effective amount of powdered antimycotic composition of known composition and concentration and uniformly mixing the composition with a pressurized air stream; conveying the bulk foodstuff past a plurality of nozzles configured to apply the antimycotic composition to each surface of the foodstuff; applying a layer of antimycotic composition to each surface of the bulk foodstuff and slicing the foodstuff into individual slices having an effective amount of antimycotic composition disposed on the cut surfaces thereof.

The methods of the present invention can also include providing an antimycotic application apparatus positioned within a cheese slice processing line, preferably, between a bulk cheese cutting equipment and a cheese slicing or cubing device. The method can include: (1) selecting or programming the process variables for a given production run on the control system, such process variables include, but not limited to, the conveyor speed, the type of antimycotic composition used, the required flowrate of antimycotic composition used, the pressure and flowrate of the air input to the system, the size and shape of the cheese logs and the desired antimycotic surface concentration; (2) loading the cheese logs on to the apparatus; (3) turning on the air flow and antimycotic composition flow to a plurality of spray nozzles; (5) applying the antimycotic composition to each surface of the cheese log while the cheese log is continuously conveyed along the application area of the apparatus; and (6) slicing the coated cheese log into a plurality of cheese slices.

Preferably, the applying step, each surface of the cheese log is substantially uniformly coated with a layer of antimycotic composition having a thickness capable of achieving an effective surface concentration of antimycotic composition on each slice of cheese from the cheese log. The applying step includes applying the antimycotic composition to the cheese log while simultaneously conveying the cheese logs from a subsequent processing station, such as the cheese log cutter, to the cheese slicer.

The methods of the present invention can further include, consistent with the broader aspects of the present invention, a determining step, wherein the concentration/thickness of the layer of antimycotic composition applied to each surface of the bulk food product (e.g. the effective amount of antimycotic composition) that is required to produce the desired or sufficient antimycotic effect and/or required to achieve the desired surface concentration of antimycotic agent in the resulting cheese slices is determined.

In preferred embodiments of the present invention, the antimycotic composition comprises natamycin. The antimycotic compositions for use in the methods of the present invention can include any GRAS antimycotic agent capable of increasing resistance of the food product against spoilage. The antimycotic compositions can also include other GRAS powdered additives including preservatives, flavor enhancers and/or anticaking compositions.

### DESCRIPTION OF THE DRAWINGS

These and other advantages of the present invention are best understood with reference to the drawings, in which:

FIG. 1 is a front perspective view of an antimycotic application apparatus for coating at least one foodstuff with a powdered antimycotic composition, in accordance with the teachings of the present invention;

FIG. 2 is a side view of the antimycotic application apparatus illustrated in FIG. 1;

FIG. 3 is a top view of the antimycotic application apparatus illustrated in FIGS. 1 and 2, shown with a food slicer positioned at the outlet of the apparatus;

FIG. 4 is a partial side view of the antimycotic application apparatus illustrated in FIGS. 1 through 3, showing a cheese log moving onto a conveyor system of the apparatus before the antimycotic composition is applied;

FIG. 5 is a partial top view of the antimycotic application apparatus illustrated in FIGS. 1 through 4, showing two cheese logs disposed therein;

FIG. 6 is a partial side view of the antimycotic application apparatus illustrated in FIGS. 1 through 5, showing the cheese logs being conveyed through the application area;

FIG. 7 is a partial side view of the antimycotic application apparatus illustrated in FIGS. 1 through 6, showing a plurality of nozzles for applying the antimycotic composition and coating each surface of the cheese log;

FIG. 8 is a rear sectional view of the antimycotic application apparatus illustrated in FIGS. 1 through 7, taken along the line 8-8 in FIG. 7, illustrating complete spray coverage of each surface of the cheese logs by the nozzles;

FIG. 9 is a partial side view of the antimycotic application apparatus illustrated in FIGS. 1 through 8, showing the cheese log having a substantially uniform coating of antimycotic composition applied thereto;

FIG. 10 is a partial top view of the antimycotic application apparatus illustrated in FIGS. 1 through 4, showing two coated cheese logs and two uncoated cheese logs disposed thereon; and

FIG. 11 is a rear view of a cheese log having a coating of antimycotic agent applied thereto;

FIG. 12A is a perspective view of a coated cheese log, shown cut into slices; and

FIG. 12B is a side view of a single cheese slice illustrating at least some of the antimycotic composition deposited on the cut surface of the cheese slice.

### DETAILED DESCRIPTION OF THE PREFERRED EMBODIMENT

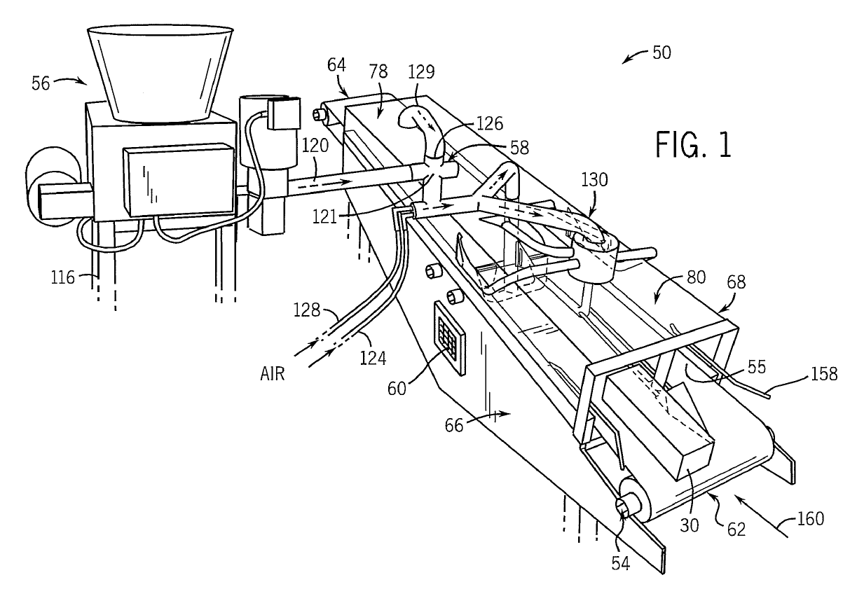

Although the disclosure hereof is detailed and exact to enable those skilled in the art to practice the invention, the embodiments herein disclosed merely exemplify the invention which may be embodied in other specific structures. FIG. 1 illustrates a preferred embodiment of an apparatus 50 for automated antimycotic application to a bulk cheese product. Further, although the invention is described with respect to cheese, the present invention can be applied to a number of different foodstuffs. It will also be appreciated that the methods of the present invention can be carried out using a variety of conventional food processing equipment, as described in more detail below. Accordingly, while the preferred embodiment has been described, the details may be changed without departing from the invention, which is defined by the claims.

The methods and apparatus described herein may be readily introduced into any food production line, in particular, foodstuffs that require slicing. As such, the apparatus 50 is arranged in the production line before a food slicer 20 (not shown in detail in the Figures). The coated bulk food item can be cut and trimmed into slices by any means known to those skilled in the art, including those as described in more detail in U.S. patent application Ser. No. 10/857,098 entitled “Method and Apparatus for Slicing Small Cheese Portions and Preparing Cheese Loaves for Slicing,” which patent is hereby incorporated herein by reference.

FIG. 1 illustrates a front perspective view of the apparatus 50 for applying a dry or powdered form of an antimycotic composition 40 to cheese logs 30. While the cheese logs are illustrated in a elongated, square or rectangular form, as in FIG. 11, the foodstuff may be of a different size or shape, for example, the cheese log may have a circular or square cross section.

Preferably, the cheese used in the present invention is a natural cheese, such as cheddar, provolone or mozzarella. However, any variety of soft, semi-hard or hard natural cheeses can be used with good effect. For example, Swiss, Monterrey Jack, Asiago, Colby, blue, and Colby-Jack cheeses can all be sliced and coated with antimycotic composition according to the methods of the present invention. In addition, processed, imitation cheeses and vegan cheeses can also be sliced and coated using the methods of the present invention. In particular, the present invention is applicable to cheeses having a variety of different fat contents, textures, porosities, etc., depending on desired consumer or market demands.

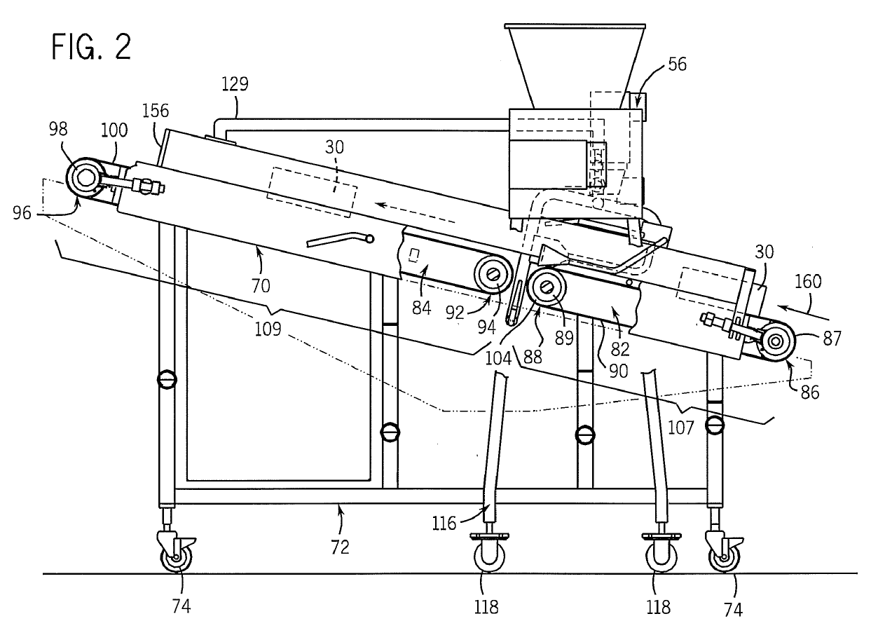

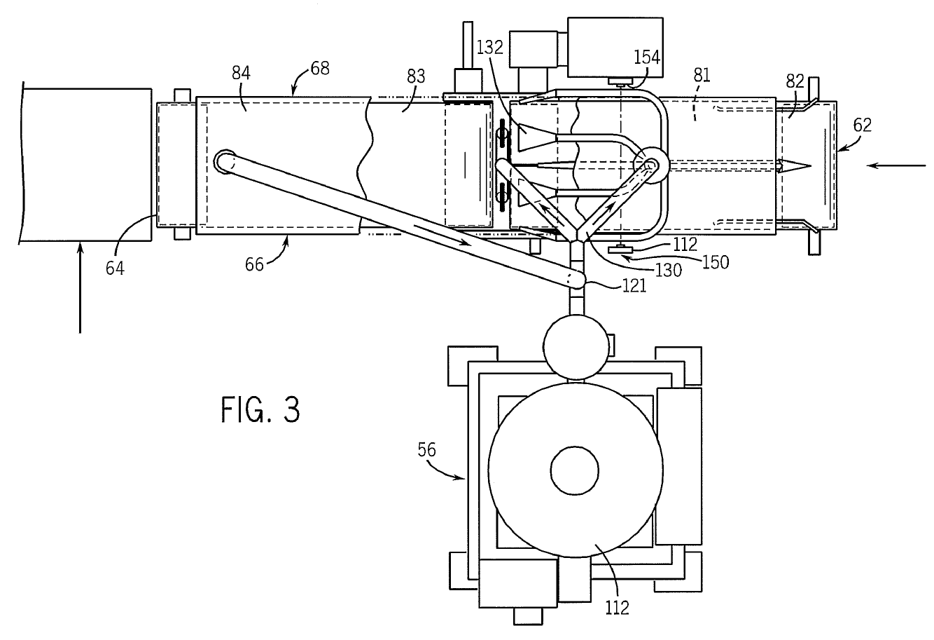

Turning also to FIGS. 2 and 3, in addition to FIG. 1, the apparatus 50 generally includes a conveyor system 54, a powder dispensing system 56, an air distribution system 58 and an electrical control system 60. The apparatus 50 has a product input end, or infeed, indicated generally at 62, and a product off-loading end, or outlet, indicated generally at 64. The apparatus 50 has a first side, indicated generally at, 66 and a second side, indicated generally at 68. The apparatus 50 is supported on a bottom side, indicated generally at 70, by a support frame 72 that preferably includes casters 74 so that the apparatus can move between production lines. A top side 78 of the apparatus 50 is substantially enclosed by at least one hood or shield 80 to provide an application area 55 for application of the antimycotic composition 40, which will be described in more detail below.

As illustrated in FIG. 2, the conveyor system 54 includes first and second conveyors, 82 and 84, which are mounted on to the support frame 72. The conveyor 82 has a front end 86 including laterally spaced pulleys 87 and a rear end 88 including laterally spaced pulleys 89. A continuous belt 90 extends around the pulleys 87 on the front end 86 and around the pulleys 89 on the rear end 88 of the conveyor (82), providing a process surface 81 for antimycotic application. Likewise, the conveyor 84 has a front end 92 including laterally spaced pulleys 94 and a rear end 96 including laterally spaced pulleys 98. A continuous belt 100 extends around the pulleys 94 on the front end 92 of the conveyor 84 and around the pulleys 98 on the rear end 96, providing a process surface 83 for antimycotic application.

Each of the belts 90 and 100 are preferably constructed of a solid urethane material for sanitation and proper friction characteristics. However, other food safe materials known to those skilled in the art can also be used with good effect. The belts 90 and 100 also preferably include a “V” guide (not illustrated) to maintain belt alignment and minimize belt slippage and may include belt scrapers to remove powder buildup within the apparatus 50.

It will be appreciated that each of the conveyors 82 and 84, are preferably configured with troughed beds having upwardly extending lateral sides to substantially enclose the sides 66 and 68 of the apparatus 50 to improve sanitation of the assembly 50. As will be appreciated by those skilled in the art, the troughed beds of each of the conveyors can be configured to retain round logs in the proper position in the conveyor system 54 during processing. A removable pan 111 runs the length of the bottom 70 of the apparatus 50 to collect powder that does not adhere to the cheese. The conveyor system is designed for complete disassembly to meet regulatory sanitation requirements.

As illustrated in FIGS. 2 and 3, the conveyors 82 and 84 are arranged from end-to end with a gap 104 therebetween to accommodate a portion of the air distribution system 58 so that the powdered antimycotic composition is directed to the underside of the logs, as will be described in more detail below. As illustrated in FIG. 2, the conveyors 82 and 84 can be arranged at an incline on the support frame 72 to transfer logs from the elevation of one process station (such as a log cutting area) to the elevation of another processing station, such as the slicer 20. It will be appreciated that support frame 72 may be adjustable to permit the apparatus 50 and each of the conveyors 82 and 84 to accommodate any inlet 62 height and/or any outlet 64 height, depending on the particular production line and production equipment.

In certain preferred embodiments, the conveyors 82 and 84 are wide enough to permit multiple cheese logs, for example, two or more cheese logs, to be conveyed within the apparatus 50 at the same time. Preferably, each of the conveyors 82 and 84 are fourteen inches wide, to allow for two, four inch wide cheese logs to be placed within the apparatus 50. However, the width of each of the conveyors may be varied, depending on the size of the foodstuff to be coated with the antimycotic composition. In addition, the first conveyor 82 has a length 107 that is preferably shorter in length 109 than the second conveyor 84. The Length 109 should be at least 1.5 times the length of the longest product length to minimize the loss of air borne powder after the application of the power by the air distribution system 58. Accordingly, in certain preferred embodiments of the present invention, the first conveyor 82 is thirty-six inches long and the second conveyor 84 is sixty inches long.

Turning again to FIGS. 1 through 3, the powder dispensing system 56 includes a feed hopper 112, a metering device 114, and a motor 116 in communication with the control system 60 of the apparatus 50. The hopper (112) retains a supply of dry, powdered and/or particulated antimycotic composition, which supplies the metering device 114. Preferably, the powder dispensing system's hopper 112 includes an open helix/screw-type feeder and is designed to prevent bridging of the powder. A powder supply feed tube 120 supplies the air distribution system 58 with antimycotic composition.

The powder dispensing system 56 is also provided on a stand 99 at a height selected for proper communication with the air distribution system 58. The stand 99 is preferably provided with casters 118 so that it is capable of moving from one production line to another.

The powder dispensing system 56 can comprise any powder dispensing device known to those skilled in the art capable of metering powder at a predetermined rate, such as those manufactured under the registered trademark Mechatron® (Schenck AccuRate, Whitewater, Wis.). It will be appreciated that the powder dispensing system 56 will be preferably one appropriate for use in food production applications and therefore, will be easily disassembled for cleaning and reassembled for use.

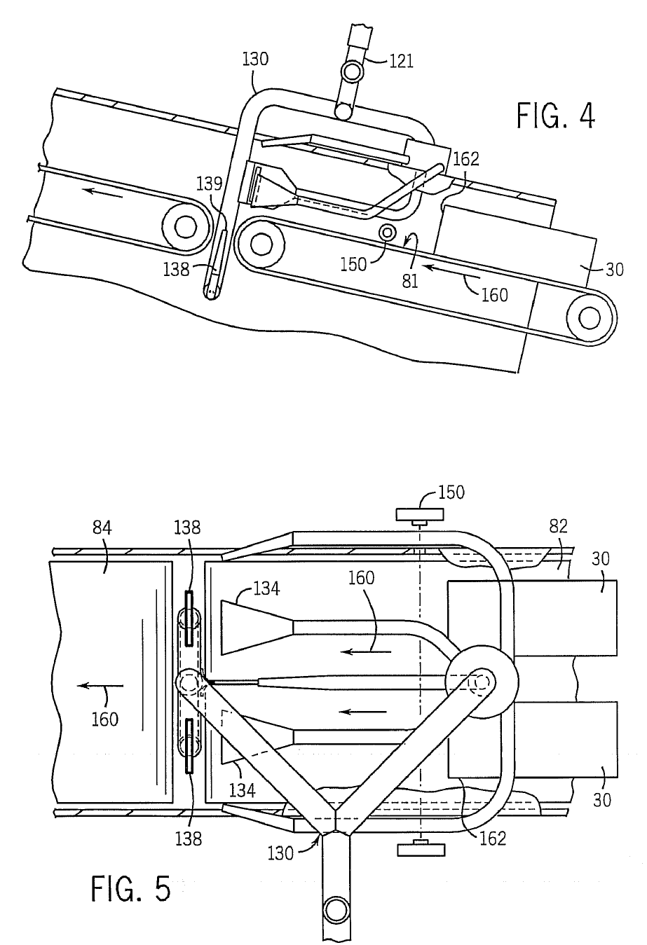

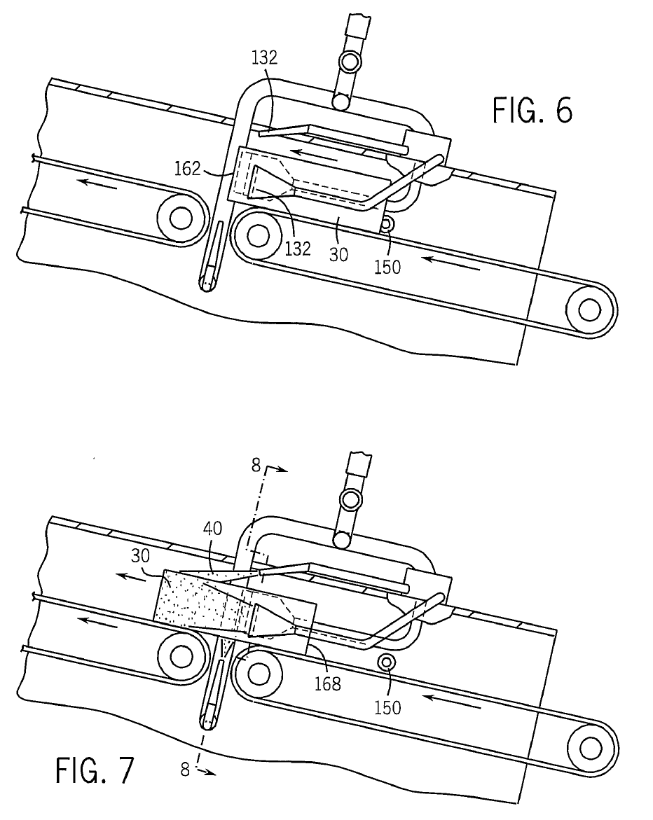

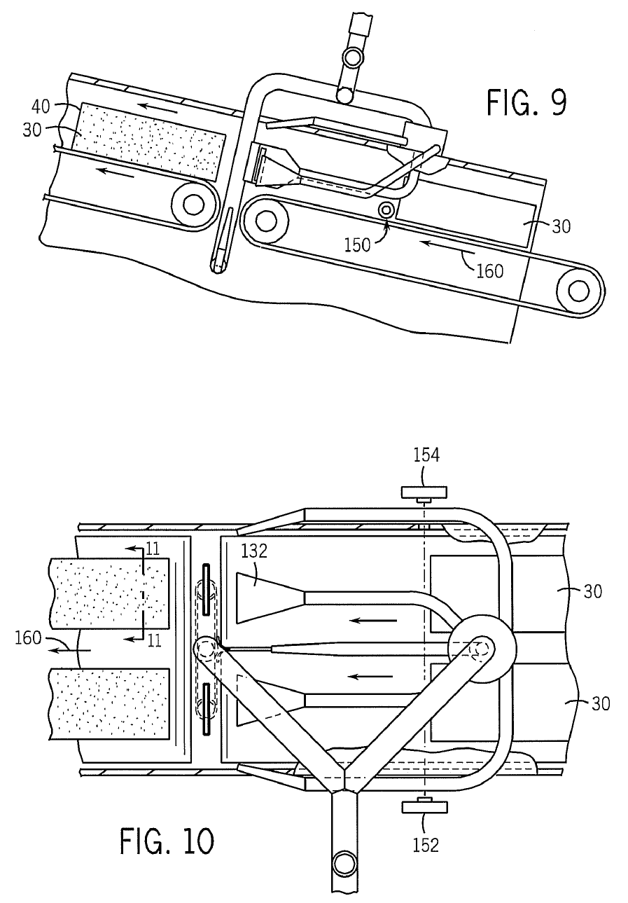

Turning now to FIGS. 4 through 10, in addition to FIGS. 1 through 3, the air distribution system 58 comprises a mixing manifold 121 having a powder inlet 122 connected to the powder supply feed tube 120, a process air inlet 124 for drawing the powder from the powder dispensing system 56 (as described below), a recirculated air inlet 126, and an air purge inlet 128.

Each of the process air 124 and air purge inlets 128 are connected to a supply of compressed air, preferably from about 80 to about 100 psi. Preferably, the air is filtered with a multistaged, vapor absorbing coalescing final filter to eliminate moisture problems associated with powder delivery. Other compressed air sources may be used and regulated as required, as will also be well known to those skilled in the art. In addition, the process air and purge air flows into the apparatus 50 are adjustable using a direct reading flowmeter.

The mixing manifold 121 is configured to adequately and uniformly disperse the required amount of powder within the air stream so that a uniform amount/layer of antimycotic composition is applied to each surface of the cheese log. To achieve this effect, the mixing manifold 121 is configured so that the high pressure, filtered air is introduced through a small tube, creating a venturi effect and a vacuum within the air distribution system 58. This effect allows powder to be drawn from the powder supply feed tube 120 of powder dispensing system 56 and aids in breaking up any clumps that may occur. The mixing manifold 121 is also configured so that the vacuum draws recirculation air from the end of the application area 55, through the recirculaton pipe 129, back to the mixing manifold 121 to minimize particulate from entering the processing plant or room where operators are working and to provide make-up air to the system, reducing compressed air requirements.

Without limitation to any particular theory or mode of operation, this venturi effect magnifies the amount of air that passes through the air distribution system 58. Accordingly, the desired air flow, and thus, the air distribution system 58 piping is designed to maintain sufficient velocities within the apparatus 50 to keep powder particles suspended as well as dispersed in the air stream.

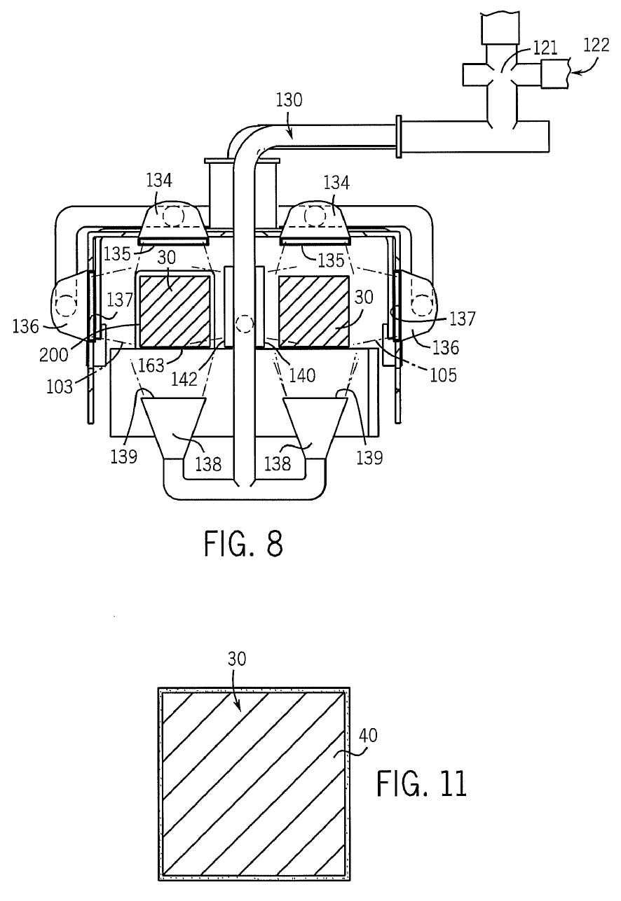

The mixing manifold 121 connects to a nozzle supply header 130 which substantially evenly divides the mixed air and powder stream among a plurality of nozzles 132. As best illustrated in FIG. 8, the preferred embodiment of the present invention includes top nozzles 134, side nozzles 136, bottom nozzles 138 and a center nozzle 140. It will be appreciated that although seven nozzles are shown in the FIGS., less nozzle or additional nozzles can also be used, depending on the size and shape of the foodstuff to be coated, the size and operational limitations of the conveyors, the type of antimycotic composition used, the limitations of the powder dispensing system 56, and the pressure of the compressed air supplied to the apparatus.

As illustrated in the FIGS., the plurality of nozzles 132 branches off from the substantially Y-shaped nozzle supply header 130, however, it will be appreciated that the nozzle supply header 130 may be configured in any manner known to those skilled in the art that provides a substantially evenly distributed flow to each of the nozzles, including use of multiple nozzle supply headers 130 and/or elimination of the nozzle supply header 130.

The top nozzles 134 are configured to enter the apparatus 50 through the top of the shield 80 near the rear end 88 of the conveyor 82. The nozzles 134 are designed to minimize the amount of piping located within the application area 55 for ease of cleaning, access and repair. The outlets 135 of each of the nozzles 134 are directed downwardly into the application area 55, but are configured so that they do not contact the cheese logs during processing.

The side nozzles 136 are each configured to enter the apparatus 50 through the shield 80, with one nozzle disposed on the side 66 of the apparatus 50 and the other nozzle 136 disposed on the side 68 of the apparatus. The nozzles 136 are also configured to minimize the amount of piping located within the application area 55. The outlets 137 of each of the nozzles 136 are directed into each side of the application area 55, but are configured so that they do not contact the cheese logs during processing.

As best illustrated in FIGS. 4 and 8, the bottom nozzles 138 extend from the nozzle supply header 130, through the shield 80 of the apparatus and through the gap 104 between the conveyors 82 and 84. The nozzles 138 are also configured to minimize the amount of piping located within the application area 55. The outlets 139 of each of the nozzles 138 are directed upwardly into the application area 55, but are configured so that they do not contact the cheese logs during processing for ease of cleaning, access and repair.

Like the bottom nozzles 138, the center nozzle 140 extends from the nozzle supply header 130, into the application area 55 of the apparatus 50 and is located substantially at the midpoint between the side 66 and the side 68 of the apparatus 50 near the gap 104 between the conveyors 82 and 84. The outlet 142 of the nozzle 140 is directed toward the outlet end 64 of the apparatus 50 within the application area 55, but is configured so that it does not contact the cheese logs during processing for ease of cleaning, access and repair.

As illustrated in FIG. 8, the size and shape of each of the nozzles 132 is selected to cause the flow of powder to fan out over a given surface 163 of the cheese log to achieve a substantially uniform layer or coating of powder across each surface of the cheese log, with all surfaces of the cheese log having substantially uniform coverage. The nozzles are configured to deliver the powdered antimycotic composition spray to the cheese log without damaging the cheese itself. The nozzles do not contact the cheese logs during application, and are configured at a distance D away from the cheese logs to prevent the antimycotic composition from simply blowing off the cheese log rather than adhering to it during the application process.

The electrical control system 60 is in communication with at least one sensor 150 and the powder dispensing system 56. Each sensor 150 is located on the apparatus 50, preferably, secured to the shield 80, in order to detect the cheese logs entering and leaving the application area 55. Each sensor 150 is preferably an ultrasonic sensor so that air borne powder does not interfere with detection of the logs. In the embodiment illustrated, a first sensor 152 is located on the side 66 of the apparatus 50 and a second sensor 154 is located on the opposite side 68 of the apparatus 50, directly aligned with the first sensor 152, to detect a cheese log. The sensors 150 may be of any type known in the art capable of detecting the presence or absence of a cheese log within the application area 55.

As described herein, the shield 80 is designed to seal above the apparatus 50 and application area 55 to minimize loss of air borne powder. The shield is preferably transparent and made of two pieces, one substantially enclosing the first conveyor 82 and another substantially enclosing the second conveyor 84. The shield 80 is preferably hinged or removable from the top side 78 of the apparatus 50 and designed for easy removal and installation of component parts, such as the piping manifold and header systems. The shield 80 may be provided with a hinged discharge door 156 to minimize powder loss. Guide rails 158 mounted to the shield 80 to maintain log location. A center guide rail 159 may also be included on the shield 80.

Turning now to FIGS. 4 through 12, in addition to FIGS. 1 through 3, a method of applying a powdered antimycotic composition to a foodstuff is now described. To prepare for operation, the apparatus 50 is positioned within a cheese slice processing line, preferably, between for example, log cutting equipment (not illustrated) and the cheese slicer 20. The infeed end 62 and the outlet 64 of the apparatus 50 are each adjusted to the proper height to achieve the incline or position required by the cutting equipment and the slicer 20.

Once turned on, the apparatus 50 is turned on, particular process variables can be selected from the control system 60. The variables can include the shape and size of the cheese logs, the space between each log within a given production run, the speed of the conveyor, the flowrate and pressure of the input air, and the required powder flow rate to achieve an evenly distributed mixed stream.

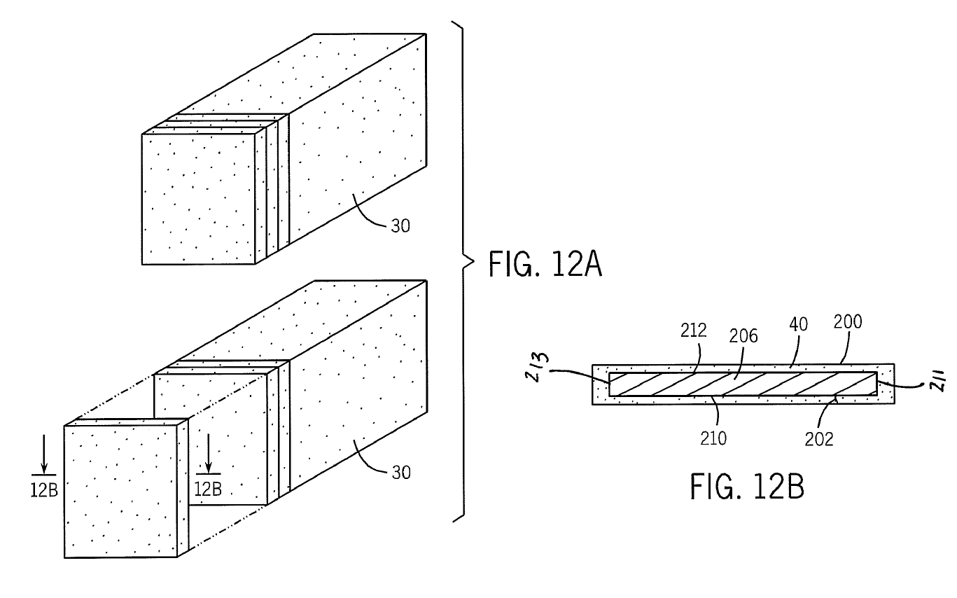

Moreover, with reference to FIGS. 12A and 12B, a particular type of cheese or foodstuff may require a specific concentration of antimycotic agent to achieve the desired antimycotic effect in the sliced food product. Further, governmental regulatory agencies limit or dictate the ratio of weight of antimycotic powder to weight of cheese and/or limit the surface concentrations of antimycotic agent permitted on the foodstuff. As such, it will be appreciated that in order to achieve the required coverage and/or concentration of antimycotic composition on the cheese after slicing, each surface of the bulk cheese product should include a substantially uniform layer or coating 200 of antimycotic composition 40 of a thickness 202 capable of providing each slice 190 with a surface concentration capable of providing the desired antimycotic effect. The thickness 202 of such layer can vary from product to product, and application to application, and therefore may change from run-to-run and will be entered into the control system 60 of the apparatus 50.

The control system 60 allows each of the belts 90 and 100 to run continuously during the production run. Turning now to FIGS. 2, 4 and 5, in a first loading step, two logs 30 are moved from the log cutting or subsequent processing equipment to the infeed end 62 of the apparatus 50 in the direction of arrow 160. The cheese logs 30 are moved on to the process surface 81 of the first conveyor 82 and enter the application area 55. As illustrated, in a first conveying step, each of the logs 30 are moved towards the sensors 150.

In a first detecting step, the presence of a front end 162 of each of the cheese logs 30 is detected by the sensors 150 as the logs are moved through the application area 55. Once the front end 162 of the logs 30 is detected, the control system 60 triggers a mixing step, in which the powder dispensing 56 and air distribution 58 systems are activated.

Preferably, the mixing step includes at least one time delay step. In particular, as the front end 162 of each log 30 passes by the sensors 152 and 154, a first “on” time delay is initiated. After this first predetermined delay, an air solenoid opens to allow high pressure compressed air to begin to flow through the piping. A second “on” time delay is also preferably initiated as the front end 162 of log 30 passes by the sensors 152 and 154. After this predetermined delay, the powder dispensing system 56 begins metering the antimycotic composition to the air distribution system 58.

In the mixing step, the antimycotic composition is drawn from the powder supply feed tube 120 of powder dispensing system 56 through the mixing manifold 121 of the air distribution system 58 by the flow of compressed air entering the mixing manifold 121, as described above. As illustrated in FIG. 7, the mixed air/powder stream flows from the manifold 121 to the nozzles 132. In the mixing step, the mixed stream is substantially equally divided among the plurality of nozzles 132. As described above, the speed of the powder dispensing system 56 can be changed to adjust the rate of powder dispensed from the metering device 114.

In an applying step, the cheese logs are conveyed past each of the nozzles, including over the gap 104 which includes the bottom nozzles 138, so that each surface of the cheese log is substantially uniformly coated with a layer of antimycotic composition having a thickness capable of achieving the required surface concentration of antimycotic composition on each slice of cheese from the cheese log. The applying step includes applying the antimycotic composition to the cheese log while simultaneously conveying the cheese logs from a subsequent processing station, such as the cheese log cutter, to the cheese slicer.

In a second detecting step, a tail end 168 of the cheese log 30 passes the sensor 150 and triggers deactivation of the powder dispensing 56 and air distribution 58 systems. In particular, after the tail end 168 of the logs 30 passes by each of the sensors 152 and 154, respectively, a first “off” time delay is initiated and then dispensing of powder from the powder dispensing system 56 is stopped. A second “off” time delay is provided, and after this delay, the air flow to the air distribution system 58 is turned off. The control system 60 is programmed to create a fault condition if the sensor 150 is blocked for longer period of time than a predetermined, preset time.

In a second conveying step, the coated cheese logs 30 are transferred onto the second process surface 83 and conveyed towards the outlet 64 of the apparatus 50.

As illustrated in FIGS. 3, 12A and 12B, in a slicing step, the coated cheese logs are sliced into a plurality of slices 206. It will be appreciated that because the thickness of the antimycotic composition across each surface of the cheese log is substantially uniform, the surfaces 211 and 213 of each slice will be substantially uniformly coated with the powdered antimycotic agent. As illustrated in FIGS. 12A and 12B, without limitation to any particular theory or mode of operation, during the slicing operation, some of the antimycotic agent on the surface of the cheese log is contacted by the slicing device and can be deposited on to the cut or sliced surfaces 210 and 212 of each cheese slice 206.

In an optional purging step, after a predetermined number of cycles, air blast periodically purges the air pipes of any powder build up. The control system 60 can also include several processing features including, but not limited to, counting the number of logs that pass through applicator; accumulating the time the powder has been dispensed; counting faults; production timing; and including a total hour timer for maintenance.

The methods of the present invention can further include, consistent with the broader aspects of the present invention, a determining step, wherein the concentration/thickness of the layer of antimycotic composition applied to each surface of the bulk food product (e.g. the effective amount) that is required to produce the desired antimycotic effect and/or required to achieve the desired surface concentration of antimycotic agent in the resulting cheese slices is determined.

In preferred embodiments of the present invention, the antimycotic composition comprises natamycin. The antimycotic compositions for use in the methods of the present invention can include any GRAS antimycotic agent capable of increasing resistance of the food product against spoilage. The antimycotic compositions can also include other GRAS powdered additives including other preservatives, antioxidants, flavor enhancers and/or anticaking compositions, as known in the art.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A method for automatically applying an antimycotic composition to sliced foodstuff:
providing a bulk foodstuff having an exterior surface and of a size capable of being fed to a food slicing device;
providing a powdered antimycotic composition at a predetermined flowrate;
mixing the antimycotic composition with a stream of pressurized air supplied at a pressure sufficient to evenly distribute the antimycotic composition within the stream;
applying an effective amount of antimycotic composition to the exterior surface of the bulk foodstuff by contacting the mixed antimycotic/air stream with the exterior surface of the foodstuff; and
slicing the bulk foodstuff into a plurality of slices.

2. The method of claim 1, wherein the bulk food stuff is a cheese log.

3. The method of claim 1, wherein the antimycotic composition comprises natamycin.

4. The method of claim 1, wherein the mixing step further comprises:
filtering the pressurized air; and
metering the antimycotic composition at a predetermined flowrate to the stream of pressurized air.

5. The method of claim 1, wherein the applying step further comprises:
spraying the exterior surface of the bulk foodstuff with the mixed antimycotic/air stream to provide a substantially uniform layer of powdered antimycotic composition on each surface.

6. The method of claim 1, wherein the applying step further comprises:
substantially equally dividing the mixed antimycotic/air stream into a plurality of mixed antimycotic/air streams; and
dispensing the antimycotic composition to the exterior surface of the bulk foodstuff using a plurality of nozzles spaced apart from the bulk foodstuff.

7. The method of claim 1, wherein the applying step further comprises:
contacting the mixed antimycotic/air stream with the exterior surface of the foodstuff while simultaneous conveying the bulk foodstuff from a subsequent bulk cutting operation to the food slicing device.

8. A method for automatically applying an antimycotic composition to a sliced cheese product:
providing a cheese log having an exterior surface, the cheese log being of a size capable of being fed to a food slicing or cutting device;
metering a powdered antimycotic composition comprising natamycin at a given flow rate to a stream of compressed air and uniformly dispersing the antimycotic composition therein;
dividing the mixed antimycotic/air stream into a plurality of mixed antimycotic/air streams, each having substantially the same flowrate;
spraying the exterior surface of the cheese log with the plurality of mixed antimycotic/air streams while the cheese log is simultaneously conveyed from a first location to the slicing or cutting device to provide a layer of antimycotic composition of substantially uniform thickness on the exterior surface of the cheese log; and
cutting the cheese log into a plurality of cheese portions, each cheese portion having at least one cut surface, wherein an effective amount of the powdered antimycotic composition from the layer of antimycotic composition on the exterior surface of the cheese log is transferred to the least one cut surface of each cheese portion.

9. The method of claim 8, wherein the providing step includes providing a plurality of cheese logs, each cheese log having an exterior surface and being of a size capable of being fed to the food slicing or cutting device.

10. The method of claim 8, wherein the metering step includes mixing the powdered antimycotic composition with compressed air having a pressure of about 80 to about 100 psi.

11. The method of claim 8, wherein the dividing step includes supplying the mixed antimycotic/air stream into a mixing manifold and then supplying the mixed antimycotic/air stream to a plurality of nozzles.

12. The method of claim 11, further comprising recirculating any antimycotic composition not applied to the exterior surface of the cheese log back to the mixing manifold.

13. The method of claim 8, further comprising determining the thickness of the layer of antimycotic composition required on the exterior surface of the cheese log in order distribute the effective amount of antimycotic composition on the at least one cut surface of each of the cheese portions.

14. In a food production operation where a plurality of bulk food products are conveyed from a first processing operation to a subsequent slicing operation, a method for applying an effective amount of a dry natamycin composition to each slice of a bulk food product, the method comprising:
dispersing an amount of the dry natamycin composition at a given flow rate to a stream of high pressure air, wherein the air is supplied at a pressure sufficient to evenly distribute the dry natamycin in the air stream;
contacting each exterior surface of the bulk food product with the mixed dry natamycin/air stream while simultaneously conveying the bulk food product from the first processing operation to the slicing operation; and
slicing the bulk food product into a plurality of slices, each slice having at least one cut surface, wherein the effective amount of the powdered natamycin composition from the bulk food product is transferred to the least one cut surface of the bulk food product.

15. The method of claim 14, further comprising contacting each exterior surface of another one of the plurality of the bulk food products with the mixed dry natamycin/air stream while simultaneously conveying the bulk food product from the first processing operation to the slicing operation.
